(19) United States
(12) Patent Application Publication
(10) Pub. No.: US 2009/0125954 A1
(43) Pub. Date: May 14, 2009

(54) STREAMING VIDEO TRANSMISSION FROM PC TO REMOTE MONITOR

(75) Inventor: Yeegee Ku, Inverness, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/171,555

(22) Filed: Jul. 11, 2008

Related U.S. Application Data
(60) Provisional application No. 60/987,598, filed on Nov. 13, 2007.

(51) Int. Cl. H04N 7/173

(52) U.S. Cl. 725/109

(57) ABSTRACT

An apparatus and method to transfer streaming video from a personal computer to a remote monitor includes the personal computer reading a compressed streaming video data from a source, transmitting the compressed streaming video data to a remotely located Ethernet stream video converter, the Ethernet stream video converter decoding the compressed streaming video data and displaying the decoded streaming video data on a remote monitor connected to the Ethernet stream video converter.

### CROSS-REFERENCE TO RELATED APPLICATIONS

This is a United States non-provisional application of U.S. provisional patent application Ser. No. 60/987,598 filed Nov. 13, 2007 by Yeegee Ku, the entirety of which application is incorporated by reference herein.

### FIELD OF THE INVENTION

Aspects of the present disclosure relate to methods and apparatus for producing streaming video at a remote point. More specifically, aspects of the present disclosure relate to sending a streaming video data from a personal computer to a remote monitor.

### BACKGROUND INFORMATION

Transfer of video signals from point to point is becoming an important capability for a variety of industrial needs. Conventionally, video signals are transmitted from point to point in low resolution formats due to a number of difficulties. These difficulties include network traffic and limited central processor unit bandwidth. Other problems also hamper transfer of video signals from point to point, such as limited monitor graphic signal driving capability.

Conventionally, streaming video data is transmitted from a server via the Internet to a personal computer. Alternatively, the video data is read on a personal computer hard disk by the central processor unit. The personal computer uses the central processor unit and software, such as a video player, to read the video files that are decoded and transmitted to a receiver. The use of the central processor unit requires significant computer resources and consequently the personal computer cannot deliver the signals to a remote monitor without extra hardware. All signals sent by the conventional methods are sent in a decoded format.

Systems used to transmit video signals with conventional methods include a personal computer with associated graphics card that interfaces with the personal computer memory. Signals obtained from the memory of the personal computer are decoded by the graphics card and are then transmitted through a transmitter to a remote receiver. The signals are then transferred to a remote monitor. The intensive use of the graphics card to decode the video files as well as extensive use of the central processor unit limits overall effectiveness of the transfer of the video file from point to point.

Referring to FIG. 3, a conventional system 300 used to transmit streaming video signals from a personal computer 301 to a remote monitor 302 is illustrated. The system 300 comprises a personal computer 301 that includes a central processing unit 308 that is in turn connected to a computer memory 310. The computer memory 310 is connected to a computer hard disk 312 and a graphics card 306. A streaming video data may be received by the personal computer 301 concurrently from an external source such as from a server over the Internet or read from the computer hard disk 312 and subsequently decoded by the central processing unit 308 and sent to the graphics card 306. Alternatively, the graphics card 306 may be configured with its own processor and memory to help decode the streaming video data transferred from the central processing unit 308 through the memory 310. The graphics card 306 outputs the decoded streaming video data in standard DVI/VGA signal and transmits the video image data to the remote monitor 302. However, because of the remote distance to the remote monitor 302, the conventional system 300 requires a video extender 303 to transmit the video image data from the graphics card 306 to the remote monitor 302. The video extender 303 comprises a transmitter 311, and a receiver 304. In this conventional system 300, however, the video extenders are generally an expensive device that adds substantial cost to the system.

### SUMMARY OF THE INVENTION

In one embodiment, an arrangement to provide streaming video to a remote location is provided comprising a personal computer, having at least an Ethernet port, a memory, a central processing unit and a data storage disk, a remotely located Ethernet stream video converter configured to receive video signals from the Ethernet port, and a remote monitor connected to the Ethernet stream video converter.

In another embodiment, a method for transfering streaming video from a personal computer to a remote monitor is provided comprising the personal computer reading a compressed streaming video data from a source, transmitting the compressed streaming video data to a remotely located Ethernet stream video converter, receiving the compressed streaming video data at the Ethernet stream video converter, the Ethernet stream video converter decoding the compressed streaming video data and displaying the decoded streaming video data on a remote monitor connected to the Ethernet stream video converter.

In another embodiment, a program storage device tangibly embodying a program of instructions executable by the machine to perform method steps for transferring streaming video from a personal computer to a remote monitor is provided. The method steps accomplished comprise the personal computer reading a compressed streaming video data from a source, transmitting the compressed streaming video data to a remotely located Ethernet stream video converter, receiving the compressed streaming video data at the Ethernet stream video converter, the Ethernet stream video converter decoding the compressed streaming video data and sending the decoded streaming video data to a remote monitor for displaying the decoded streaming video.

### BRIEF DESCRIPTION OF THE DRAWINGS

FIG. 1 is a schematic interconnection diagram of an arrangement to stream video from a personal computer to a remote monitor.

FIG. 2 is a flow chart illustrating a method to stream video from a personal computer to a remote monitor.

FIG. 3 is a interconnection diagram of a prior art streaming video system.

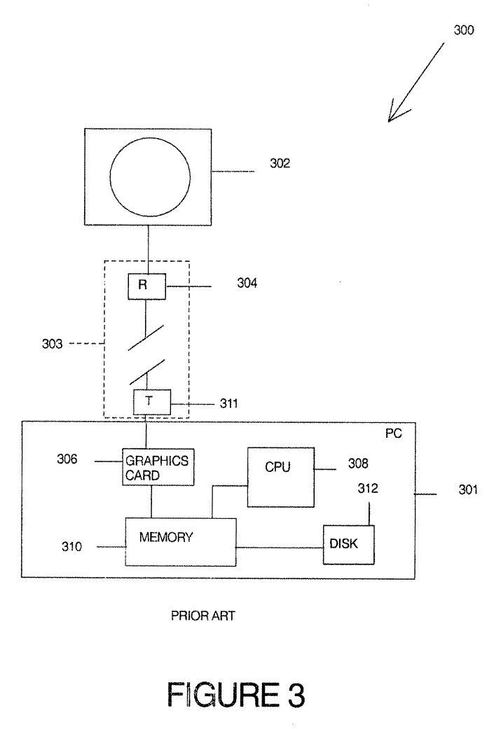

FIG. 4 is a schematic diagram of an Ethernet stream video converter.

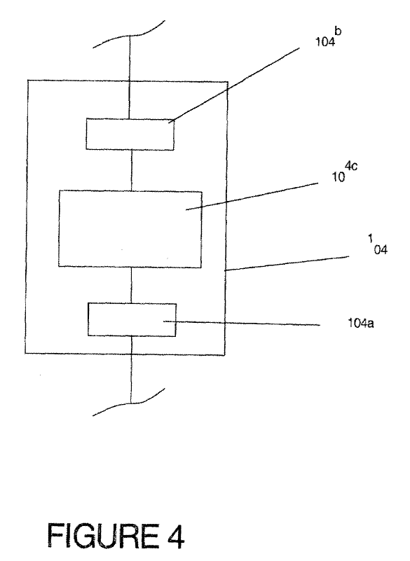

### DETAILED DESCRIPTION

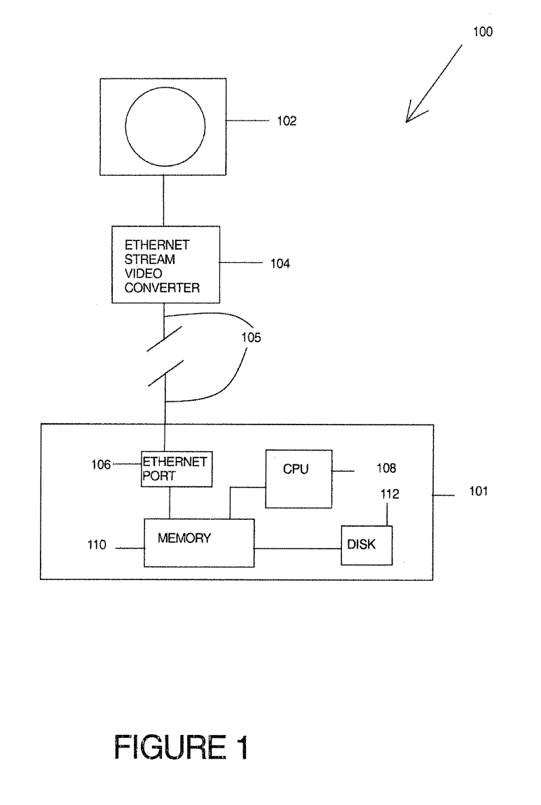

Referring to FIG. 1, a system 100 for providing streaming video data from a personal computer 101 to a remote monitor 102 is illustrated. In the non-limiting embodiment illustrated, the personal computer 101 is configured with a data storage disk 112, a memory 110, a central processor unit (CPU) 108 and an Ethernet port 106.

The data storage disk 112 of the personal computer system 101 may be any typical data storage device, including, but not limited to a computer hard disk, a flash memory, and a digital video disk, floppy disk and magnetic tape. A computer memory 110 is connected to the disk 112, the central processor unit 108 and the Ethernet port 106. The computer memory 110 in the illustrated embodiment is a random access memory (RAM) that may retain data as provided by the central processor unit 108 and the disk 112. The memory 110 may be configured as SDRAM, DDR, DRAM, for example The memory 110 may also come in different form factors, such as DIMMs and RIMMs. The memory speed, column address strobe latency, cache size and cache number may be varied according to the size and speed desired in transmitting the streaming video data.

According to an embodiment, the personal computer system 101 may receive a compressed streaming video data, such as compressed high resolution streaming video data from a remote source over a communications network and store it in the personal computer system 101 data storage disk 112 or the memory 110 The source of such compressed streaming video data may be a file that resides in another personal computer or a server that is connected to the personal computer 101 via the communications network. The communications network may be a wired connection or wireless connection and may includes networks formed by wide area networks (WAN), local area networks (LAN), etc. The communications network also may be connections over the Internet. In the context of the present disclosure the personal computer 101 “receiving” the compressed streaming video data from a source is used interchangeably with the term “reading” the compressed streaming video data from a source.

The central processing unit 108 is a logic machine that is configured to execute computer programs. The programs may be internally stored within the central processing unit 108 or may be stored in the memory 110 or disk 112. The central processing unit 108 in the illustrated embodiment is a microprocessor that is made from interconnected integrated circuits The clock rate for the central processing unit 108 may be chosen to optimize the performance of the personal computer 101.

The Ethernet port 106 is connected to the personal computer memory 110. The Ethernet port 106 accepts compressed streaming video data stored in the personal computer memory 110 or the data storage disk 112 and transmits the compressed streaming video data to the Ethernet stream video converter 104. According to another embodiment, the personal computer 101 may receive the compressed streaming video data from a source over a communications network (such as a remote server connected to the personal computer 101 over the Internet) and concurrently transmit the compressed streaming video data to the Ethernet stream video converter 104. In the illustrated embodiment, the Ethernet stream video converter 104 is remotely positioned from the personal computer 101. The Ethernet stream video converter 104 decodes the compressed streaming video data into standard video output signal, e.g. DVI/VGA format, and displayed on the remote display 102. The Ethernet port 106 may be, for example, 1000BASE-T, 1000BASE-SX, 1000BASE-LX, 1000BASELX10, 1000BASE-BX10, 1000BASE-CX, 1000BASE-LH or 1000BASE-ZX. The speed of the Ethernet port 106 in the illustrated embodiment is one gigabit per second as defined by IEEE 802.3-2005 standards. Other Ethernet standards may be used, including 10 gigabit Ethernet standards or 100 gigabit Ethernet standards, therefore the speeds of the Ethernet may be modified as needed.

The Ethernet stream video converter 104 is configured in a field programmable gate array (FPGA) based solution that includes an Ethernet controller, a converter, a display memory and a display controller. By using the arrangement 100 provided in FIG. 1, the compressed streaming video data is transmitted from the personal computer 101 to the remotely located Ethernet stream video converter 104 at the remote display 102 instead of larger decoded video data. The compressed streaming video data is decoded at the Ethernet stream video converter 104 so there is no need to use a video extender, as in conventional systems. Furthermore, because the decoding of the compressed streaming video data is performed by the remotely located Ethernet stream video converter 104 connected to the remote display 102, the system 100 uses less CPU resources. The system 100 of the illustrated embodiment also eliminates any need for a graphic card thereby making a more economical design.

In another embodiment, the arrangement is further configured with an Ethernet cable 105 connecting the personal computer 101 and the Ethernet stream video converter 104. The Ethernet cable 105 may be a CAT5 Ethernet cable. The Ethernet port may be a Gigabit Ethernet port.

In another embodiment, the arrangement is further configured such that the Ethernet stream video converter 104 has at least an Ethernet port 104a for connecting to the personal computer 101, a graphic port 104b for connecting to the remote monitor 102, and a processor 104c that comprises an Ethernet controller, a video data converter, a display memory and a display controller. The graphic port 104b may be a DVI/VGA connector and the remote monitor 102 may be configured with a DVI/VGA connector.

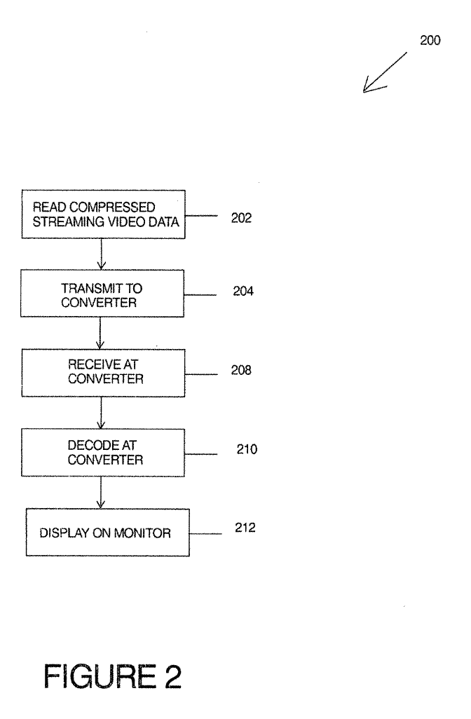

Referring to FIG. 2, a method 200 to transfer streaming video from a personal computer to a remote monitor is provided. The method 200 comprises the personal computer 101 reading a compressed streaming video data from a source file (see block 202). The compressed streaming video source file may be a file pre-stored in the data storage disk 112 or concurrently received from a remote source such as a remote server (not shown), over a network such as the Internet. The personal computer 101 transmits the compressed streaming video data via the Ethernet port 106 to a remotely located Ethernet stream video converter 104 (see block 204). The method 200 further comprises receiving the compressed streaming video data at the Ethernet stream video converter 104 (see block 208), the Ethernet stream video converter 104 decoding the compressed streaming video data (see block 210), and displaying the decoded streaming video data on the remote monitor 102 connected to the Ethernet stream video converter 104 (see block 212). In the illustrated embodiment, because compressed streaming video data is transmitted to the remote monitor 102 via the remotely located Ethernet stream video converter 104, the processing resource of the central processing unit 108 is freed up for other functions.

In a further embodiment, the method may also be accomplished such that the decoding of the compressed streaming video data produces DVI/VGA display images. The method may also be performed wherein the compressed streaming video data may be stored as a file in the personal computer's memory 101 and the reading of the compressed streaming video data from the source by the personal computer 101 is performed from a computer memory 110. The method may also be performed wherein the compressed streaming video data may be stored as a file in the personal computer's data storage disk 112 and the reading of the compressed streaming video data from the source by the personal computer 101 is performed from the data storage disk 112.

The arrangement 100 provides for high resolution streaming video to be sent from a source to a remote monitor 102 that may be, for example, 100 meters distant from the source. The arrangement 100 does not require the use of a high performance central processing unit 108 because the streaming video data transmitted to the remote monitor from the personal computer 101 is in compressed form without decoding by the central processing unit 108. Thus, the arrangement 100 is more efficient in sending streaming video data from the personal computer 101 to the remote monitor 102.

In the foregoing specification, aspects of the invention have been described with reference to specific embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. An arrangement to provide streaming video to a remote location, comprising:
a personal computer, having at least an Ethernet port, a memory, a central processing unit and a data storage disk;
a remotely located Ethernet stream video converter configured to receive video signals from the personal computer via the Ethernet port; and
a remote monitor connected to the Ethernet stream video converter.

2. The arrangement according to claim 1, further comprising:
an Ethernet cable connecting the personal computer and the Ethernet stream video converter.

3. The arrangement according to claim 2, wherein the Ethernet cable is a CAT5 Ethernet cable.

4. The arrangement according to claim 1, wherein the Ethernet port is a Gigabit Ethernet port.

5. The arrangement according to claim 1, wherein the Ethernet stream video converter has at least an Ethernet controller, a converter, a display memory and a display controller.

6. The arrangement according to claim 1, wherein the remote monitor is configured with a DVI/VGA connector.

7. A method to transfer streaming video from a personal computer to a remote monitor, comprising:
reading a compressed streaming video data from a source by the personal computer;
transmitting the compressed streaming video data to a remotely located Ethernet stream video converter;
receiving the compressed streaming video data at the Ethernet stream video converter;
the Ethernet stream video converter decoding the compressed streaming video data into a decoded streaming video data; and
displaying the decoded streaming video data on a remote monitor connected to the Ethernet stream video converter.

8. The method according to claim 7, wherein the decoding of the compressed streaming video data produces DVI/VGA display images.

9. The method according to claim 7, wherein the reading of the compressed streaming video data from the source by the personal computer is performed from a computer memory.

10. The method according to claim 7, wherein the reading of the compressed streaming video data from the source by the personal computer is performed from a computer data storage disk.

11. A program storage device readable by a machine, tangibly embodying a program of instructions executable by the machine to perform method steps for transferring streaming video from a personal computer to a remote monitor, comprising:
reading a compressed streaming video data from a source by the personal computer;
transmitting the compressed streaming video data to a remotely located Ethernet stream video converter;
receiving the compressed streaming video data at the Ethernet stream video converter;
the Ethernet stream video converter decoding the compressed streaming video data into a decoded streaming video data; and
displaying the decoded streaming video data on a remote monitor connected to the Ethernet stream video converter.

12. The program storage device according to claim 11, wherein the reading of the compressed streaming video data from the source by the personal computer is performed from a computer memory.

13. The program storage device according to claim 11, wherein the reading of the compressed streaming video data from the source by the personal computer is performed from a computer data storage disk.

14. The arrangement according to claim 1, wherein the Ethernet stream video converter is a field programmable gate array based converter.

15. The arrangement according to claim 14, wherein the Ethernet stream video converter comprises an Ethernet controller, a video data converter, a display memory and a display controller.
